(19) United States
(12) Patent Application Publication
(10) Pub. No.: US 2002/0044570 A1
(43) Pub. Date: Apr. 18, 2002

(54) METHOD AND APPARATUS FOR IMPROVED COMMUNICATION FOR CABLE TV TELEPHONY AND DATA TRANSPORT

(75) Inventors: ARAVANAN GURUSAMI, EAST SYRACUSE, NY (US); R. GARY HEYMAN, EAST SYRACUSE, NY (US); KIRAN BABU, MANLIUS, NY (US)

Correspondence Address: CORPORATE PATENT COUNSEL, US PHILIPS CORPORATION, 580 WHITE PLAINS ROAD, TARRYTOWN, NY, 10591

(73) Assignee: Philips Electronics North America Corp.

(21) Appl. No.: 08/759,667

(22) Filed: Dec. 6, 1996

(51) Int. Cl. H04N 7/173

(52) U.S. Cl. 370/487; 714/746; 714/747; 725/106

(57) ABSTRACT

Cable TV providers have an infrastructure which is well suited for providing additional services such as telephone and data connections to their subscribers. Techniques are disclosed for improving the error detection, masking, and avoidance capabilities of such a system. Because the system can distinguish telephony from data traffic, alternate error masking techniques can be employed for each type of traffic. An erroneous telephony packet, for example, can be replaced by silence, because the ear is relatively insensitive to short voids. Additionally, the links to the data or telephony provider can be maintained by the cable provider during interim noise periods. Because the network is structured as a multiple access network, and the likelihood of simultaneous upstream messages from all subscribers is low, error monitoring can be implemented on underutilized equipment to effect error avoidance, both as a preventive measure as well as a corrective measure.

### BACKGROUND OF THE INVENTION

1. Field of the Invention

This invention generally relates to signal transmission and processing, and specifically to a method and apparatus for providing robust and reliable telephone and data service to Cable TV subscribers.

2. Discussion of the Related Art

Cable Antenna Television (CATV) Networks provide an established network infrastructure for high speed communications.

Traditionally, CATV networks operate solely as broadcast networks. Information, in the form of television programs, is transferred one way, from the CATV headend to the CATV subscribers. With the advent of advanced technologies and changes in the regulatory restrictions, CATV network operators have an opportunity to use their network infrastructure to provide additional services to their subscribers (see FIG. 1). These services will include, for example, telephone service, internet access, video on demand, etc. These additional services will require the networks to handle high speed, high bandwidth communications both to and from the subscriber, and, to be successful, will be required to be highly robust and reliable.

Communication from many subscriber locations to a central location such as a CATV headend imposes significant obstacles due to a multitude of interfering sources present in the return frequency band. Additionally, the service provided is not “self contained”, and capabilities must be provided for effectively interfacing with the telephone service provider at the CATV headend, particularly with regard to noise and error handling within the CATV telephony and data network.

Traditional error correcting techniques are often unsuitable in the CATV environment, because the CATV noise and performance environment are characteristically different than other environments. For example, CB radio interference is often experienced on CATV. Traditional telephone lines, operating at low frequencies, are not affected by these transmissions. Traditional noise filters are ineffective, because the interference is often of the same magnitude as the CATV signal, and the interference is not characteristically Gaussian. Such interference is often sporadic and of relatively long duration. While dealing with such noise, the CATV network must maintain the appropriate connection and protocol with the upstream telephone provider, to prevent an unwanted disconnect.

Despite the above difficulties, the high bandwidth infrastructure of the existing and proposed CATV networks allows for performance enhancements which are unachievable or impractical for other communication systems. The bandwidth provided by CATV to each home, for example, is significantly broader than that provided by a common telephone line. This offers the CATV network provider more options for dynamically adjusting performance in the presence of interference. Also, the CATV provider typically is the sole provider of this high bandwidth capability to the home, and as such, is able to mandate the equipment capability at each subscriber location. Features and functions desirable for robust and reliable communication can be designed into the interface unit at the subscriber location, as well as at the CATV headend.

Another factor which affects the characteristics of a CATV telephony and data service is in the area of error correction and masking. Different types of service have different performance considerations and requirements. For example, voice communication is more tolerant of voids and less tolerant of delay, whereas data communication, in this environment, is relatively delay insensitive. A CATV network is not limited to voice transmissions, and does not require data transmissions to be converted by modems to voice frequencies, as in traditional telephone lines. The network can distinguish between telephony and data, and apply error correction or concealment schemes best suited to each.

This invention addresses the problems characteristic of a CATV telephony and data service, and provides solutions which take advantage of the technological characteristics and capabilities inherent in a CATV network. Specifically, the invention provides for generating and recovering signals which provide robust upstream communication in the presence of interference; provides identification, correction, and masking of errors; and, maintains circuit connectivity and dynamic reconfiguration in the presence of noise disturbances.

### SUMMARY OF THE INVENTION

This invention discloses “error concealment” for short duration noise disturbances. For particular applications, the substitution of a specified pattern in place of a corrupted packet can minimize the effect of the corruption. Additionally, the concealment of the errors from further upstream processes can be invoked to maintain connectivity during intermittent outages.

This invention also discloses means for measuring the noise and/or performance of each channel in a non-interfering manner. In so doing, corrupted channels can be locked out during periods of high interference, clear channels can be identified, and selected transmitters can be switched to alternative channels, as required, to improve performance.

### BRIEF DESCRIPTION OF THE DRAWINGS

FIG. 1 shows a Bidirectional CATV Network.

FIG. 2 shows a CATV Headend for Bidirectional Services.

FIG. 3 shows the RF Spectrum Usage for a Bidirectional CATV Network.

FIG. 4 shows the use of Time Division Multiplexing (TDM) and Time Division Multiple Access (TDMA) for Downstream and Upstream communication, respectively, in a Bidirectional CATV Network.

FIG. 5 shows the structure of the Downstream TDM transmission stream.

FIG. 6 shows the structure of the Upstream TDM transmission stream.

FIG. 7 shows the downstream, transmit, portion of the CATV Headend modem.

FIG. 8 shows the upstream, receive, portion of the CATV Headend modem.

### DETAILED DESCRIPTION OF THE PREFERRED EMBODIMENT OF THE INVENTION

System Operation

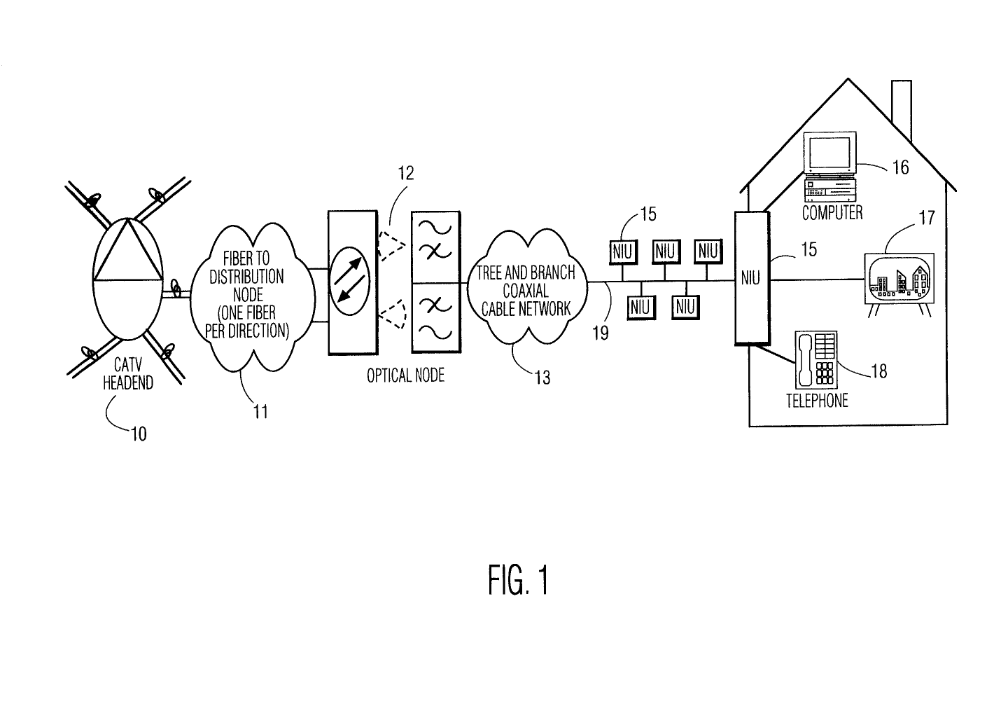

FIG. 1 shows a Bidirectional Cable Television (CATV) network for providing television, telephony, and data services to a subscriber. The CATV Headend 10 is the distribution center for all communications to and from the subscriber. At the CATV Headend would be the interfaces, not shown, to the telephone service provider(s), the data service provider(s), as well as the television service provider(s). In an exemplary configuration, the CATV Headend 10 transmits information over fiber-optic cables 11, one fiber for downstream (transmit) communications, and one fiber for upstream (receive) communications. At a local substation, the optical communication is converted 12 to electronic signals, and vice versa. The electronic signals are communicated over a coaxial cable network 13. Multiple Network Interface Units (NIUs) 15 are connected to a branch of this cable network. Typically, there would be one NIU per subscriber residence. Each NIU 15 provides the necessary interface to the subscriber's television 17, telephone 18, and computer 16. This invention addresses the equipment required at the CATV Headend 10 and the NIUs 15 to effectively and efficiently provide the bidirectional data 16 and telephony 18 services to the subscriber.

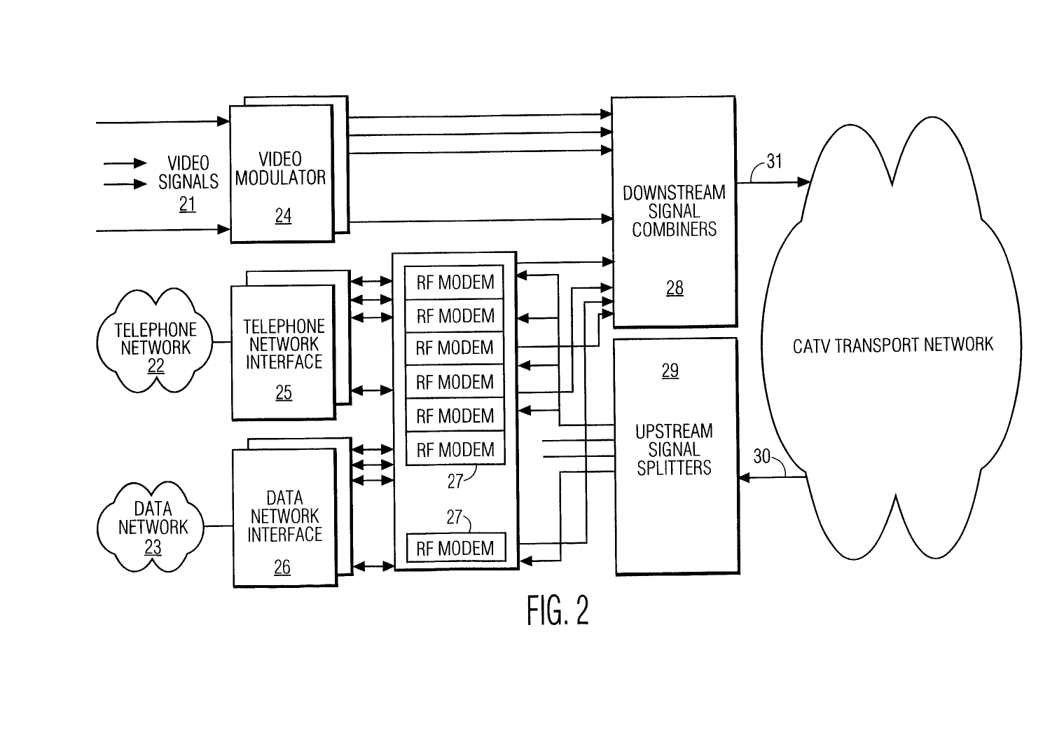

The CATV Headend components are shown in FIG. 2. The CATV Headend comprises the video modulator 24 for the television/video signals 21, the interface 25 to the telephone network 22, and the interface 26 to the data network 23. The telephone and data signals are modulated and demodulated in the RF Modems 27. The modulated signals, from the video modulator 24 and the RF Modems 27 are combined 28 to form a frequency multiplexed downstream signal 31. The upstream signal 30, which is also frequency multiplexed, is demultiplexed at splitter 29 into individual signals for demodulation by the appropriate RF Modem 27. Each RF modem 27 is assigned a transmit, downstream, frequency and a receive, upstream, frequency.

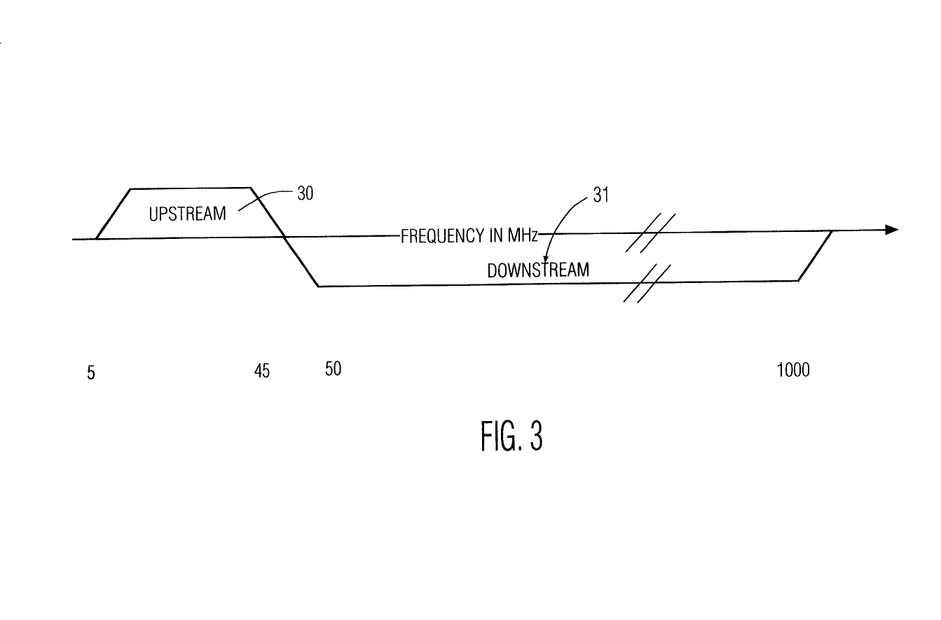

The frequency allocation for upstream and downstream communication is shown in FIG. 3. The upstream signal 30, which is the frequency multiplexed combination of all the subscribers' upstream telephony and data communication, occupies the 5 MHz to 50 MHz band. The downstream signal 31, which is the frequency multiplexed combination of the television/video signals as well as the subscribers' downstream telephony and data communications, occupies the 50 MHz to 1000 MHz band.

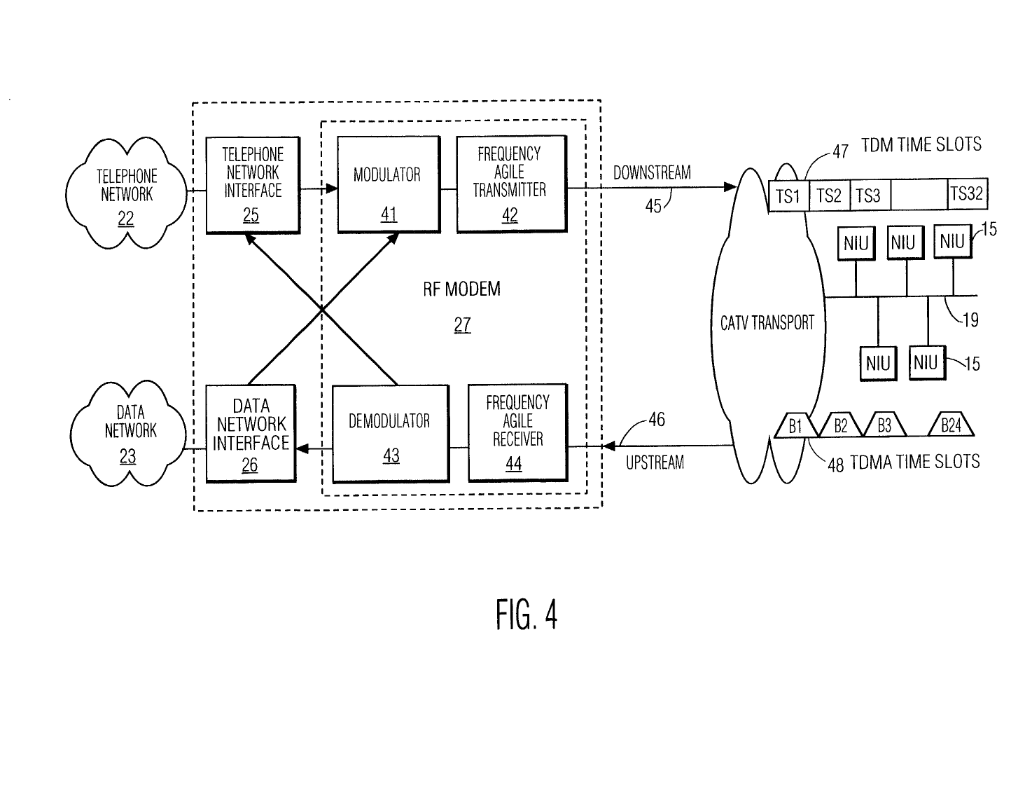

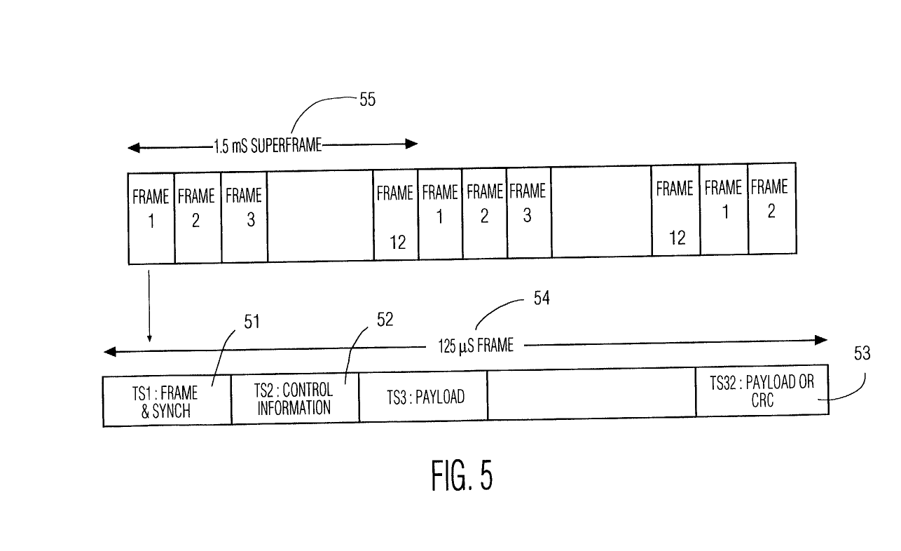

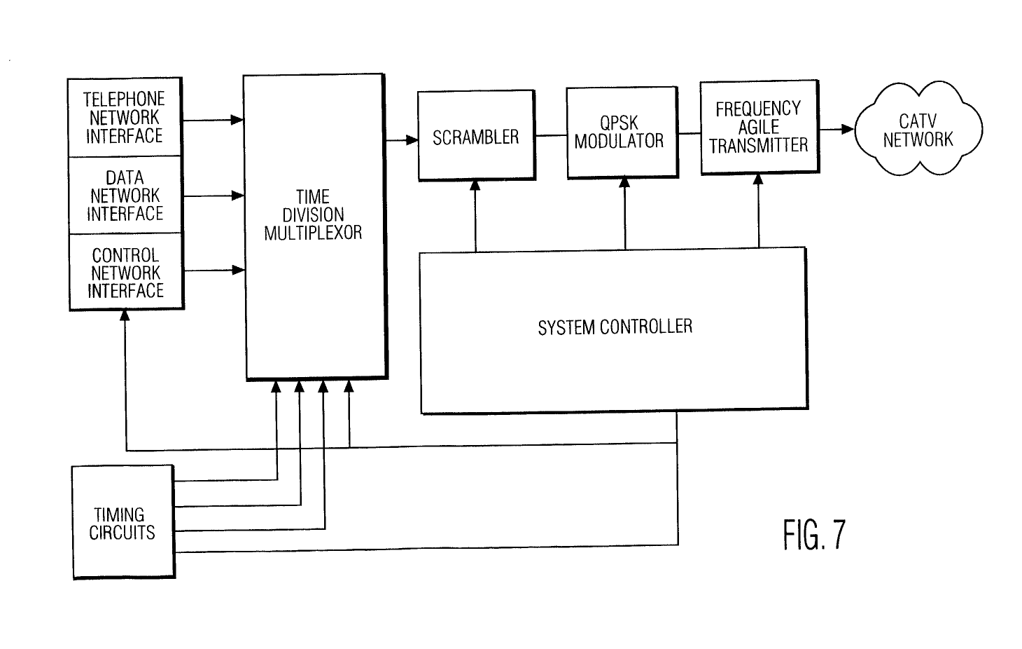

Within the frequency multiplexed downstream signal 31 and upstream signal 30, the telephone and data signals are further multiplexed in the time domain, as shown in FIG. 4. Shown in FIG. 4 is the RF Modem 27 of FIG. 2, comprising a modulator 41, a radio frequency transmitter 42 and receiver 44, and a demodulator 43. The downstream signal 45 is one of the signals comprising the frequency multiplexed downstream signal 31, and the upstream signal 46 is one of the signals comprising the frequency multiplexed upstream signal 30. The downstream signal 45 is delineated into thirty two time slots 47. Each NIU 15 is assigned one or more of these time slots. The assignment can be static, wherein the assignment does not change, or dynamic, wherein the assignment of a time slot to an NIU is dependent upon the demand for service from each NIU. As shown in FIG. 5, the first time slot 51 is assigned for timing and synchronization. The second time slot 52 contains control information, and this control information could contain the signalling for the dynamic assignment of subsequent time slots to each NIU. The last time slot 53 can be assigned for error correction signalling. In the preferred embodiment, the 32 time slots comprise a 125 microsecond frame period 54. Twelve frame periods form a 1.5 millisecond superframe. The downstream superframe also forms a timing sequence for the upstream communication as discussed below. The headend transmitter, which transmits this downstream communication, is shown in FIG. 7.

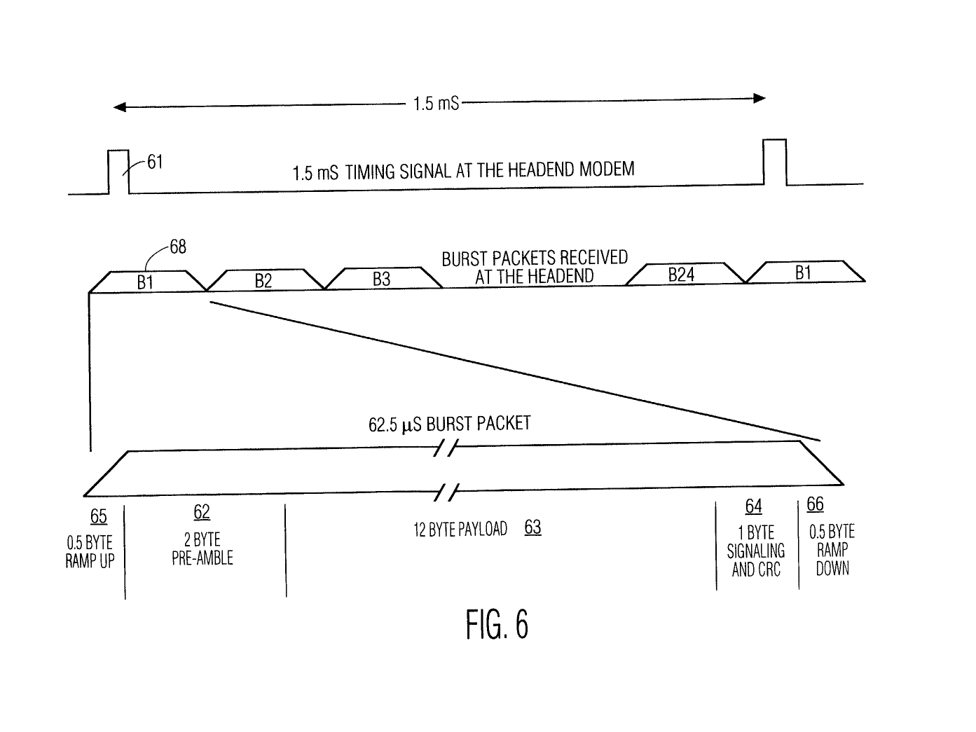

The upstream signal 46 is delineated into time slots, one or more of which are assigned to each NIU 15 for upstream communication. The headend modem transmits a timing signal 61 as part of the downstream signal 45 at each 1.5 ms superframe, as shown in FIG. 6. The transmission from each NIU is specified to be 62.5 microseconds long, and comprises two bytes of preamble 62, twelve bytes of payload 63, and one byte of signalling and error correction 64. One byte length is allocated for NIU ariance, a half byte at the beginning 65 and at the end 66 of the transmission.

Maintaining Circuit Connectivity

The preamble contains a predefined data pattern. The detection of an error in the preamble, being highly indicative of the status of the communications link to the subscriber, is used to initiate corrective and preventive measures, as follows.

The service providers, that is, the telephone company, the data provider, etc., often use the presence of errors or noise within the payload, or on the signal carrying the payload, as an indication of a communications link problem. These providers often disconnect the subscriber from the service in the event of such problems. Or, because of noise or interference, the service providers may misinterpret the contents of the payload, or the characteristics of the carrier, as a purposeful termination of the connection. Typically, for example, an on-line data service will disconnect a noisy connection for a perceived loss of carrier signal. The carrier is rarely absent, it is more often overcome by noise, but the data service equipment has no means for distinguishing the difference between a broken link, or a misinterpreted command, from an intended disconnect. The subscriber in such a situation is required to reinitiate the contact. This may be a time consuming process, for example, if the link the subscriber had established on this data service was via a complicated search process, as might be typical while communicating on the World Wide Web. Or, it may require the reentry of significant amounts of information if the data service provider has an insufficient back up system.

In accordance with this invention, however, the CATV can distinguish the absence of a response from the NIU from a corrupted response, by directly observing the characteristics of the received preamble. If the preamble is present, but corrupted, the CATV headend, in accordance with this invention, will interject the appropriate signalling to the provider to preclude a disconnect for at least a predefined period of time while it initiates corrective actions. This will prevent, for example, the disconnection of the subscriber caused by a corrupted payload which is misinterpreted as a purposeful disconnect. If the preamble is absent, this would signify either a purposeful disconnect, or a problem with the NIU. A problem with the NIU can be detected by noting its response in other timeslots, or by its response to a test request in this timeslot. Alternatively, the protocol could require an explicit control signal to signify a purposeful disconnect. Absent this signal, the headend will automatically hold off the service disconnect for a predefined period of time, and initiate corrective actions.

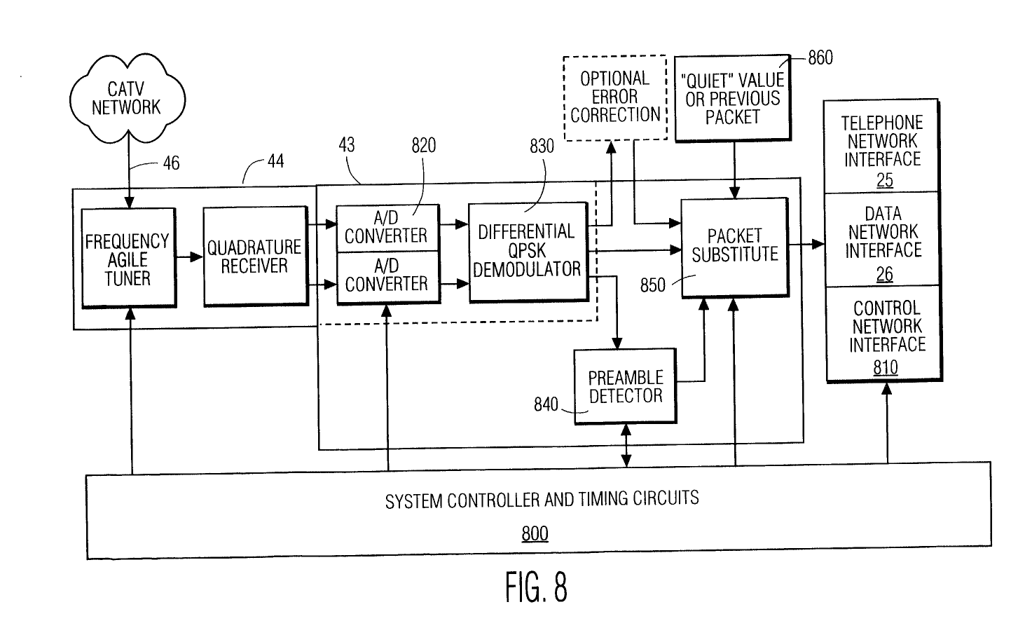

FIG. 8 shows a block diagram for a headend receiver and demodulator in accordance with this invention. As also shown in FIG. 4, QPSK signals are received from the upstream link 46 by receiver 44, and provided to the QPSK demodulator 43. QPSK demodulator 43 comprises the Analog to Digital converters 820 and differential QPSK demodulator 830. In accordance with this invention, demodulator 43 also comprises the preamble detector 840 which, as discussed above, provides for direct preamble error detection. And, in accordance with this invention, demodulator 43 also comprises packet substitution means 850 which will be subsequently discussed. If a preamble error is detected, the System Controller 800 receives a signal from the preamble detector 840. In response to this signal, system controller 800 communicates with the Control Network Interface 810, which then communicates with the appropriate interface 25 or 26 to preclude a disconnect from the service provider, as discussed above, for a predetermined period of time. The controller also initiates corrective actions in response to a preamble error, as will be disclosed herein.

Error Concealment

In accordance with this invention, the Packet Substitution block 850, in response to a preamble error signal from preamble detector 840, may substitute a different packet for the packet which was received with the preamble error. Voice communications have been found to be very sensitive to noise and delay, but fairly tolerant of high frequency losses. In accordance with this invention, if a packet error is detected, and the packet is associated with telephony, voice, communications, a substitute packet 860 will replace the packet received from 830. This substitute packet will either be a packet which is equivalent to “quiet”, i.e. the absence of sound, or a packet which is identical to the previous, non-preamble-error, packet. In so doing, the recipient of this information will not hear the noise or static typically heard as a result of the occurrence of erroneous signals, and the perceived quality of communication from this equipment will be higher. By invoking this substitution, however, any information contained in the replaced packet which was not contained in the prior packet will be lost. If a subsequent packet is received without error, however, the loss will be limited to the information contained in the replaced packet which was not contained in either the prior nor the subsequent packet, i.e., only rapidly occurring changes of information will be lost. Note also that by employing this packet substitution method, it is unnecessary for voice communications to attempt to correct errors; thus, the bytes optionally allocated for error correction can be allocated to carry message information, thereby reducing the packet overhead.

For data communications, a loss of information may be intolerable. Because the CATV equipment can be configured to communicate with the subscriber's data equipment separately from the subscriber's telephone equipment, independent error correction schemes can be employed. In accordance with this invention, the system controller 800 interacts with the packet substitute block 850 to preclude packet substitution if the received packet is associated with the data network interface 26. optionally, those errors in the payload which are correctable by the CRC bits in the signalling and CRC byte 65 of FIG. 6 can be corrected by the Error Correction block 870. Alternatively, the data communication protocol could provide for error detection at the higher network layers. For example, the data service provider could request a retransmission from the subscriber's data equipment in the event of detected errors.

Corrective Measures

In response to a detected error, or a symptom of a potential future problem, the CATV headend can initiate corrective measures not available to traditional telephony or data service providers. As shown in FIGS. 2-5, the system comprises RF modems 27 and NIUs 15 which comprise frequency adjustable transmitters and receivers. In the event of errors or degradation, these tuners can be adjusted to a frequency with less interference. In accordance with this invention, the detection of degradations, as well as the a priori assessment of alternative frequencies, are both provided, thereby providing for an efficient corrective process with minimal, if any, interruption of service to the subscriber. During this reassignment of frequency, connectivity is maintained with the service providers for all affected NIUs, as discussed above, through the control network interface 810.

In addition to the detection of errors or degredation during the transmission and reception of subscriber packets, the CATV headend will initiate periodic diagnostics. Periodically, the each RF modem will request the transmission of a known data packet from a selected NIU. The transmitted data packet will contain a predefined pattern in both the preamble as well as the payload. The comparison of the received pattern with the predefined pattern will provide an immediate assessment of the quality of the transmission path, at the currently allocated frequency. The selected NIU can be chosen either randomly, or dependent upon the NIU's location, for a determination of location dependent interference patterns. The results of the comparison can also be stored over time, for the assessments of trends or the identification of repeating interference patterns, such as interferences which recur at particular times each day.

The CATV headend will also contain at least one diagnostic RF modem for the assessment of unused RF frequencies. Periodically, an NIU will be selected, and, via its assigned RF modem, will be instructed to change its operating frequency to a currently unused frequency. At least one NIU of each RF modem's network will be selected, so as to assess each unused frequency's interference characteristics on each network. If all the NIUs in the network have subscriber traffic, the diagnostic process may be postponed for this network.

The diagnostic RF modem, set to the aforementioned currently unused frequency, will commence its diagnostics by requesting transmissions from the selected NIU. The diagnostic RF modem will subsequently instruct the NIU to change its frequency again. The new frequency will either be another unused frequency, or, the NIU's original operating frequency. The choice can be made to be dependent upon whether the NIU has subscriber messages to transmit. Within the CATV headend, a record of each network's interference characteristics at each unused frequency, and the network's current frequency, will be maintained. A network's frequency will be reassigned whenever an unused channel exhibits an interference characteristic which is significantly better than the characteristics of the network's current frequency. The record of interference characteristics will also be used to initiate equipment maintenance procedures, should the record indicate equipment problems, rather than external interference patterns.

Conclusion

As discussed above, this invention comprises means for detecting, concealing, and correcting errors, as well as means for anticipating problems and initiating corrective actions before the problems become apparent to the user. Through the use of these techniques, the bi-directional services provided by a CATV provider will have a quality and robustness not heretofore available to a telephone or data service subscriber.

The foregoing merely illustrates the principles of the invention. It will thus be appreciated that those skilled in the art will be able to devise various arrangements which, although not explicitly described or shown herein, embody the principles of the invention and are thus within its spirit and scope. For example, certain features of this invention were presented with a particular direction of the communications flow. It will be appreciated by one skilled in the art that the terms “upstream” and “downstream” are relative to the source and destination nomenclature; a change in such nomenclature may effect a reversal of terms, with no material impact. Similarly, although described in an environment with one headend and multiple downstream devices, the principles embodied by this invention are equally applicable to multisource, multidestination networks, point to point networks, or any combination thereof.

What is claimed is:

1. A receiver for receiving packets of telephony and data signals from a transmitter, characterized in that the receiver processes each packet for subsequent transmission to an upstream device, wherein said receiver comprises:
means for detecting an error in a received packet,
means for producing a first replacement packet,
means for producing a second replacement packet, and,
means for determining whether said received packet contains a telephony signal or a data signal,
wherein said subsequent transmission to the upstream device consists of the transmission of
the received packet, if an error was not found,
the first replacement packet if an error was found and the received packet contains a telephony signal,
the second replacement packet if an error was found and the received packet contains a data signal.

2. A receiver as in claim 1, wherein
said first replacement packet is a packet corresponding to a packet which would have been received had the input to the transmitter been silence.

3. A receiver as in claim 2, wherein
said second replacement packet is the received packet.

4. A receiver as in claim 1, wherein
said second replacement is the received packet.

5. A receiver as in claim 4, wherein
said first replacement packet is a packet corresponding to a previously received packet.

6. A receiver as in claim 1, wherein
said first replacement packet is a packet corresponding to a previously received packet.

7. A receiver as in claim 6, wherein
said second replacement packet is the received packet.

8. A receiver for receiving packets of signals from a transmitter, characterized in that the receiver processes each packet for subsequent transmission to an upstream device, wherein said receiver comprises:
b means for maintaining communications link with the upstream device,
means for detecting an error in the received packet,
wherein upon the detection of an error, said receiver maintains said communications link with the upstream device.

9. A receiver as in claim 8, wherein
said means for maintaining a communications link with the upstream device comprises
means for generating replacement packet, and
said subsequent transmission to the upstream device consists of the transmission of said replacement packet.

10. A receiver for receiving packets of telephony and data signals on a multiple frequency network from multiple transmitters, wherein each transmitter transmits said packets at a transmission frequency assigned to said transmitter, and each transmitter comprises means for changing its assigned frequency of transmission in dependence upon the receipt of a change frequency command, and each transmitter further comprises means for transmitting a packet in dependence upon the receipt of an execute test command, said receiver comprising:
means for receiving said packets on any of said assigned frequencies,
means for communicating a change frequency command to each transmitter,
means for communicating an execute test command to each transmitter, and
means for assessing the noise content of the packet received in response to said execute test command, wherein
said receiver communicates a change frequency command to one or more of said transmitters in dependence upon said noise content.

11. A process for selecting a frequency of transmission for transmitting packets of telephony and data signals on a multiple frequency network comprised of multiple transmitters and a receiver, said receiver having the ability of transmitting commands to each of said transmitters, each of said transmitters having the ability to transmit said packets at one of multiple transmission frequencies, and further having the ability to change said transmission frequency upon receipt of a change frequency command from said receiver, and further having the ability to send a packet in response to an execute test command from said receiver, said process comprising the steps of:
transmitting a first execute test command from said receiver to a first transmitter operating at a first transmission frequency,
receiving a first packet from said first transmitter in response to said first execute test command,
processing the first packet to form a first noise factor,
transmitting a second execute test command from said receiver to a second transmitter operating at a second transmission frequency,
receiving a second packet from said second transmitter in response to said second execute test command,
processing the second packet to form a second noise factor,
comparing said first noise factor to said second noise factor, and
transmitting a change frequency command to said first transmitter to effect a change of frequency of said first transmitter from said first transmission frequency to said second transmission frequency in dependence upon said comparison of noise factors.

12. A transmitter for transmitting packets of telephony or data signals on a multiple frequency network to a receiver which comprises means for communicating a change frequency command to said transmitter, and means for communicating an execute test command to said transmitter, wherein said transmitter comprises:
means for transmitting said packets at one of a multiple of transmission frequencies,
means for receiving said change frequency command from said receiver,
means for receiving said execute test command from said receiver,
means for changing said transmission frequency in dependence upon the receipt of a change frequency command, and
means for transmitting a packet in dependence upon the receipt of an execute test command.
